(19) United States
(12) Patent Application Publication
(10) Pub. No.: US 2009/0060413 A1
(43) Pub. Date: Mar. 5, 2009

(54) Anti-intrusion device for fences or the like

(75) Inventors: Federico Ciordinik, Bologna (IT); Roberto Doni, Modena (IT)

Correspondence Address: Themis Law, 7660 Fay Ave Ste H535, La Jolla, CA, 92037, US

(73) Assignee: DEF S.P.A., Fiorano Modenese (IT)

(21) Appl. No.: 11/718,516

(22) PCT Filed: Sep. 15, 2005
(86) PCT No.: PCT/EP05/54579

§ 371 Date: May 3, 2007

(30) Foreign Application Priority Data
Nov. 3, 2004 (IT) SV2004A000039
Sep. 15, 2005 (EP) PCT/EP05/54579

(51) Int. Cl. G02B 6/00

(52) U.S. Cl. 385/13

(57) ABSTRACT

An anti-intrusion device for fences or the like, comprising at least one, preferably two or more cables (3), each one composed of at least one or a bundle of optical fibres (103) and of an outer protection sheath (203), which optical fibre cables (3) are subtended in a substantially longitudinal direction of a section or a perimeter to be protected and are supported or holded each one at a different height at a plurality of supporting points spaced apart arranged and wherein, at least at some of said supporting points, first means (8, 9) deforming and/or blocking each optical fibre cable (3) are provided, which first deforming and/or blocking means (8, 9) may be moved from a rest position in which they do not interfere with the optical fibre cable (3) to an active position deforming and/or blocking the optical fibre cable (3) in which an optical signal transmitted through the optical fibre cable (3) is attenuated under a predetermined threshold value or it is anyway modified, and which first deforming and/or blocking means (8, 9) are automatically operated upon an increase in stretching the optical fibre cable (3), for example due to a pull/deflection action exerted on the optical fibre cable (3), characterized in that said first deforming and/or blocking means (8, 9) are housed in a box provided with two box parts (5, 6) that can be separated and coupled one with the other, inside this box there being provided means (13, 12, 208) for anti-tampering and for signalling the opening of the box that are operated deforming and/or blocking the optical fibre cable (3) upon a relative movement separating said two parts (5, 6) of the housing box.

The present invention relates to an anti-intrusion device for fences or the like, comprising at least one, preferably two or more cables, each one composed of at least one or a bundle of optical fibres and of an outer protection sheath, which optical fibre cables are subtended in a substantially longitudinal direction of a section or a perimeter to be protected and are supported or holded each one at a different height at a plurality of supporting points spaced apart arranged and wherein, at least at some of said supporting points, first means deforming and/or blocking each optical fibre cable are provided, which first deforming and/or blocking means may be moved from a rest position in which they do not interfere with the optical fibre cable to an active position deforming and/or blocking the optical fibre cable in which an optical signal transmitted through the optical fibre cable is attenuated under a predetermined threshold value or it is anyway modified, and which first deforming and/or blocking means are automatically operated upon an increase in stretching the optical fibre cable, for example due to a pull/deflection action exerted on the optical fibre cable.

Devices of the type just described are known which are used for protecting particularly risky areas such as airports or the like, generally in combination with conventional fences, for example made of an electrowelded net supported by poles. A first type of said anti-intrusion devices provides that, at a front-end axial junction point of the two optical fibre cables, a connector is provided, by means of which the junction between the two optical fibre cables is disconnected upon an attempt of intrusion, thus obtaining a total interruption of the signal. However, in making these connectors a high precision is required, so that the mechanical manufacture thereof is considerably expensive. Moreover the signal interruption effect is not automatically reversible. A second known type of these anti-intrusion devices provides the use of three different components, the first of which is a real anti-intrusion member acting on a cable, for example made of steel, that is horizontally arranged outside the real fencing net. Upon an increase in stretching or upon a cut of said metal cable, one of the two peaks blocks an optical fibre cable that is arranged vertically on a pole supporting the fence. It is further provided a protecting case for the device with a tampering signaller acting when the case is opened. Said second member acts on a further optical fibre cable that is horizontally stretched taut outside the fencing net by means of a peak operated by a spring. The third component is composed of metal cable- or optical fibre cable-fastening block on some fence poles. As it is clear, the device just disclosed is very complicated and expensive, since it provides the use both of a real anti-intrusion device and of a tampering signaller, as well as the presence of at least two distinct optical fibre cables to accomplish its tasks and the use of opposing elastic means such as springs or the like that can be subjected to malfunctions due for example to deterioration caused by atmospheric agents. In fact anti-intrusion signal is provided by the deformation of optical fibres that are subtended between struts, while the signal about attempts in tampering deforming and/or blocking means is generated by anti-tampering means acting on a further different optical fibre cable. Therefore the known arrangement needs a greater amount of optical fibres since it is necessary to provide also various optical fibres associated to the anti-tampering device. Moreover anti-tampering means cause the manufacturing to be complicated and expansive even regarding installation time and regarding the mounting easiness.

Therefore the present invention aims at overcoming drawbacks disclosed above and at allowing the manufacturing of an anti-intrusion device of the type described hereinbefore with simple and not expensive means, allowing an effective protection of fences or the like, upon an intrusion attempt causing the optical signal transmitted by an optical fibre cable to lower under a predetermined threshold value by means of at least a reversible deformation of said cable, without having to interrupt the optical fibre cable itself and thus rendering a many times transition possible from the conductive state to the interruptive or attenuation state, and vice-versa. A further important object is that of unify the fence anti-intrusion function and the device anti-tampering function in the same optical fibre cable, limiting the amount of said expensive cable that is used and therefore allowing a considerable saving, and avoiding the presence of any complicated mechanism, particularly the use of elastic means such as springs or the like.

The invention attains the above aims by means of an anti-intrusion device of the type described hereinbefore wherein said first deforming and/or blocking means are housed in a box provided with two box parts that can be separated and coupled one with the other. Inside this box there can be provided means for anti-tampering and for signalling the opening of the box that are operated deforming and/or blocking the optical fibre cable upon a relative movement separating said two parts of the housing box.

Anti-tampering means of the box housing first deforming and/or blocking means may be composed of second means deforming and/or blocking the optical fibre cable itself that are operated deforming and/or blocking the optical fibre cable by the relative movement separating the two parts of the box.

The housing box may be composed of a stable bottom wall and of a movable cover part, while second means deforming and/or blocking the optical fibre cable may be composed at least of two members that are constrained to the box bottom wall. Said two deforming and/or blocking members can be moved from a position not interfering with the optical fibre cable in the closed condition of the box, to a position deforming and/or blocking the optical fibre cable by means of activation means constrained to the inner face of the cover when the latter is in an intermediate position moving away from the box bottom wall.

The stable bottom wall and the movable cover part can have mutual engagement and coupling centering means intended to prevent relative transversal movements between said two box parts, such that the coupling/uncoupling of the cover part to/from the bottom wall occurs according to a predetermined fixed direction.

Said fixed direction for coupling/uncoupling the cover part to/from the box bottom wall can be orthogonal to the box bottom wall and to the inner face of the cover. To this aim, the box bottom wall and the cover part may be provided with complementary mutual coupling/uncoupling guides that are oriented perpendicularly to the box bottom wall and to the inner face of the cover.

According to a preferred embodiment of the invention that will be disclosed in more details in the illustration of drawings, said coupling/uncoupling guides may be composed at least of a pair of substantially cylindrical pins coming out perpendicularly from the inner face of the cover part. Each of said two pins may be provided in a position corresponding to that of one of two tubolar pins, that is with a substantially cylindrical axial hole, coming out perpendicularly from the box bottom wall such that, when the cover part approaches the bottom wall for closing the box, each one of the two cover pins by axially sliding engage inside the hole of the corresponding tubular pin provided on the box bottom wall.

According to an improvement, there can be provided complementary movable engagement means, for example of the snap type, by forcing or the like, between each pin of the cover part and the corresponding tubolar pin of the box bottom wall.

According to a further improvement, there can be provided means for stopping the insertion of each pin of the cover part in the hole of the corresponding tubolar pin of the box bottom wall.

Said movable engagement means can be composed for example of at least a radial enlargement, particularly an annular one, of the outer cylindrical wall of each pin of the cover part and/or of at least a radial narrowing, particularly an annular one, of the inner cylindrical wall of the inserting hole of each of the two tubolar pins of the box bottom wall, and/or vice-versa.

According to a preferred embodiment, each pin of the cover part can have a final fork-like end with radially enlarged and rounded head that cooperates with an annular radial narrowing of the inserting hole of the corresponding tubolar pin of the box bottom wall. The relative axial position between the edge of the inserting hole and the inner radial narrowing of the inserting hole and the relative axial position between a stop abutment radial step on the corresponding pin of the cover part and the radially enlarged head of the fork-like end of the pin of the cover part can be such that, in condition stopping the insertion of one pin of the cover part inside the insertion hole of the corresponding tubolar pin of the box bottom wall, the radially enlarged head of the pin of the cover part is passed at the back of the radial narrowing of the insertion hole, referring to the direction of insertion, so to firmly maintain the cover in the condition coupled to the bottom wall.

Second deforming and/or blocking means having the function anti-tampering and signalling the opening of the cover may be composed of a first blocking member arranged in a stable way in the box bottom wall and provided with a pair of peaks delimiting a notch, and of a second blocking member, cooperating with the first blocking member, that is a wedge-like or peak-like one faced on the notch and it can be elastically deformed in the direction of the notch. Between said two members the optical fibre cable can be perfectly interposed with regards to the distance between the faced tips. A third pushing member can be further provided, constrained to the inner face of the cover part providing to move the second blocking wedge-like member in the direction of the hollow of the first blocking member from a position not interfering with the optical fibre cable in the closed condition of the box, to a position deforming and/or blocking the optical fibre cable between the second blocking wedge-like member and faced double peaks of the first blocking member when the cover is in an intermediate position moving away from the box bottom wall.

According to a preferred embodiment, the third pushing member may be oriented perpendicularly to the cover inner face and the first blocking member with double peaks may be oriented perpendicularly to the bottom wall of the box. However, the second blocking wedge-like member, in rest condition not deforming and/or blocking the optical fibre cable, may be oriented substantially perpendicularly to the box bottom wall, while, in intermediate moving away position of the cover from the bottom wall of the box, it is oscillated by the third pushing member in the direction of the optical fibre cable and of the faced hollow of the first blocking member.

The second wedge- or peak-like blocking member may have, near its free end, an enlarged part or an enlargement extending in a direction opposite to that of the wedge, while the pushing member constrained to the inner face of the cover may have, near its free end, a corresponding enlarged region or an enlargement oriented in the direction of the second wedge-like blocking member. Thanks to this arrangement, when the box is closed and the cover completely approaches the bottom wall, the second blocking wedge-like member is oriented perpendicularly to the bottom wall of the box and it does not interfere with the optical fibre cable, while, when the cover is partially moved away from the bottom wall of the box, the two enlargements cooperate one with respect to the other and the second wedge-like blocking member is elastically deformed and it oscillates in the direction of the optical fibre cable that is deformed and pushed inside the notch of the first blocking member, causing the optical signal transmitted through the cable to be attenuated.

Each of the two enlargements of the second wedge-like blocking member and of the pushing member may be composed for example of a projection, particularly a lenticular one, having at least a rounded shape, or the like.

However, in a preferred embodiment, the enlargement provided on the pushing member constrained to the inner face of the cover may have an eccentric V-shaped section, with a shorter and steeper face oriented in the direction of the free end of the pushing member and a longer and less steep face that descends gradually in the direction of the foot attaching the pushing member to the inner face of the cover. On the other hand the enlargement provided on the second wedge-like blocking member may have also an eccentric V-shaped section, with a shorter and steeper face oriented in the direction of the free end of the wedge-like blocking member and a longer and less steep face that gradually descends in the direction of the foot attaching the wedge-like blocking member to the box bottom wall.

First deforming/blocking means that are operated upon an increase in stretching the cable due for example to a pull/deflection action exerted thereon, may be composed of a pair of jaws that are opposite mounted and at opposite parts with respect to the optical fibre cable and are freely pivotable on pins in the direction of the axis of the optical fibre cable. Said jaws, at rest condition, engage with a predetermined force two opposite regions of the outer sheath of the optical fibre cable without deforming it, while, upon an increase in stretching the optical fibre cable, they are dragged by the cable itself so to pivot by a circle arc in the direction of stretching/pull exerted on the optical fibre cable, causing the optical fibre cable to be deformed and/or blocked causing the transmitted optical signal to be varied.

Optical fibre cable or cables can be fastened or supported, each one at a different height, at a plurality of vertical or substantially vertical struts, such as poles or the like, that are spaced apart arranged. At least at some of said vertical struts, a box housing first and second deforming/blocking means can be provided.

Each one of the two jaws may be composed of a fork-like member pivoted at tip region in a free pivotable manner on a cylindrical pin coming out perpendicularly from the box bottom wall. The two pins may be provided on opposite sides with respect to the optical fibre cable and may be arranged perpendicularly to the axis of the strut and to the axis of the optical fibre cable. The two fork-like jaws may be arranged in a common plane parallel to the axis of the strut and coplanar with the optical fibre cable, and can be arranged symmetrically with respect to the optical fibre cable and with mutually faced openings. Ends of said fork-like jaws, at rest position of fork-like jaws, may be in contact with the outer sheath of the optical fibre cable so to achieve at least an engagement of only the outer sheath with the optical fibre cable by friction or a slight compression.

Each end of a first pivotable fork-like jaw may be made with a pointed or peak-like shape, while each end of the second pivotable fork-like jaw may have a pair of tips or peaks side by side that delimit a V notch with a shape substantially complementary to each one of two peaks of the first fork-like jaw. Each peak of the first fork-like jaw may be arranged at such a distance from the corresponding double peak of the second fork-like jaw to engage substantially perfectly and/or slightly compressing without deformation the only outer sheath of the optical fibre cable, at rest condition of pivotable fork-like jaws.

Tips of peaks of first fork-like jaw and tips of double peaks of the second fork-like jaw, upon an increase in stretching the optical fibre cable, may moved in the direction of the increase in stretching along circle arc paths that are at least tangent, particularly slightly intersecting one with respect to the other, so that a portion of the optical fibre cable is deformed and/or blocked between the peak of the first jaw and the faced double peak of the second jaw arranged more distant from the point where the pull action is applied on the optical fibre cable.

Advantageously, the cover part may be provided with lateral openings for perfect passage of the optical fibre cable.

According to a solution that is very advantageous as regards the construction, the two pins around which the two fork-like jaws pivot may be composed of the same two tubolar pins fastening the cover part to the box bottom wall.

The first anti-tampering blocking means with double peak may be arranged in the gap comprised between the two branches of the second fork-like jaw and the optical fibre cable, while the second wedge-like blocking and anti-tampering means may be provided in the gap comprised between two branches of the first fork-like jaw and the optical fibre cable, or vice-versa.

Tips of the double peaks of the first blocking member may be coplanar with tips of the two pairs of peaks of the second fork-like jaw, while the tip of the wedge of the second wedge-like blocking member may be coplanar with the tip of peaks of the first fork-like jaw.

According to a preferred embodiment, the second pivotable fork-like jaw has also the function of the first blocking member. To this aim, on the side turned towards the optical fibre cable, it has a notched surface composed of a row of six peaks, preferably symmetric, and with their tips contained in a same plane. The two central peaks and the hollow delimited thereby are the first anti-tampering blocking means, while each one of the two pairs of end peaks cooperate with one peak of the first fork-like jaw with anti-intrusion function.

First deforming/blocking means in combination with means signalling the opening or tampering of said deforming/blocking means may be provided only at points fastening the cable of only some of struts. Hence, at least a strut without said deforming/blocking means can be provided interposed between two struts provided with said means, while on said struts without said first deforming/blocking means there can be provided simple means fastening the cable to said struts. Advantageously, they can be housed in an openable box, that as regards the outside is substantially equal to the box housing first deforming/blocking means, and therefore it cannot be distinguished therefrom.

Even in this case, the box housing fastening means may have a bottom wall and a cover part that can be movably coupled one with the other, and means signalling the opening and/or tampering of the box can be provided between cover and bottom wall.

Advantages of the present invention are clear from what said above, and mainly are the very easiness in manufacturing and mounting the device. In fact, the two functions for fence anti-intrusion and for system anti-tampering are unified in a single device acting on a single optical fibre cable. That allows to avoid a second optical fibre cable, that, as it is known, it is very expensive. Moreover, there are no opposing mobile means such as springs or the like, that can be subjected to deterioration particularly due to action of atmospheric agents. Finally, the device does not provide the total interruption of the optical fibre cable, so that the resetting of the condition of the normal conduction of signal can substantially automatically occur.

Further characteristics and improvements are object of subclaims.

Characteristics of the invention and advantages derived therefrom will be more clear in the following detailed description of annexed figures, in which:

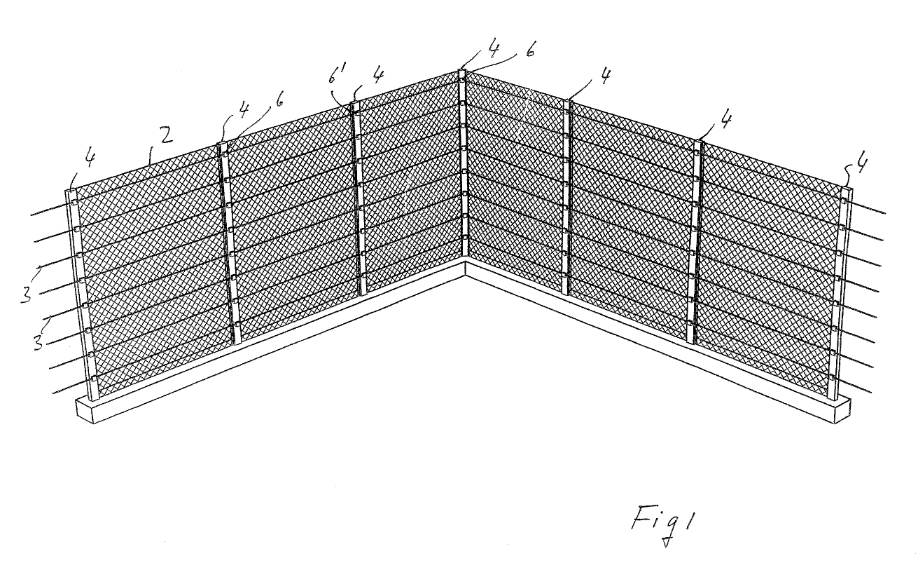

FIG. 1 is a perspective view of an anti-intrusion device according to the present invention in combination with a section of conventional fence.

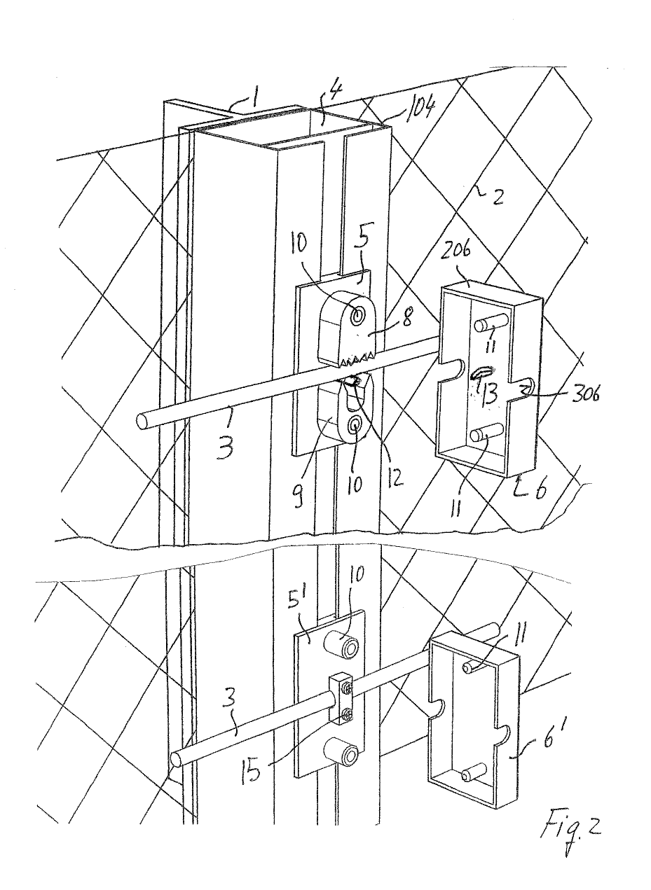

FIG. 2 is a perspective view of a strut upon which two boxes are applied one containing means for deforming/blocking the optical fibre cable with anti-intrusion function for the fence and anti-tampering function for the device and the other one containing means for fastening the optical fibre cable, covers of the two boxes being in the open condition.

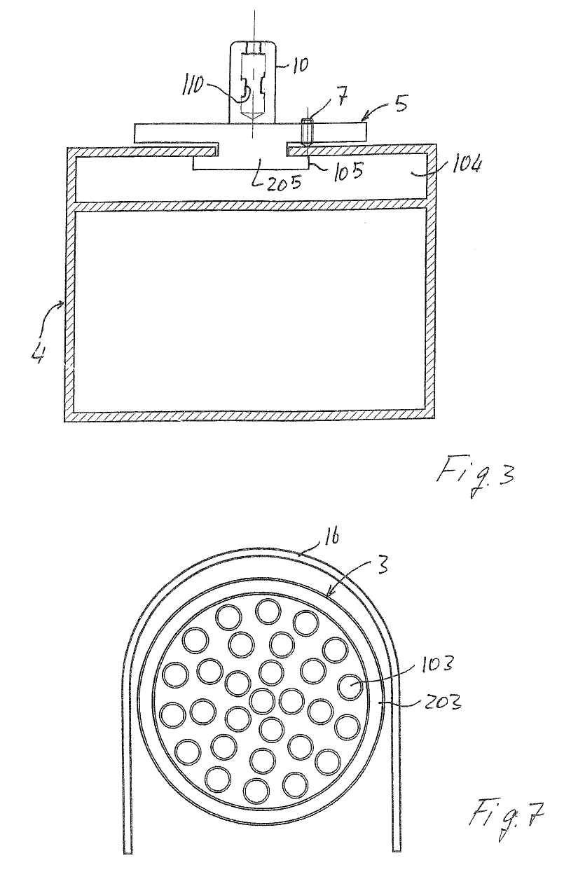

FIG. 3 is a partially cross-sectional top view of the box bottom wall intended to contain means for deforming/blocking the optical fibre cable, in the condition applied on a strut.

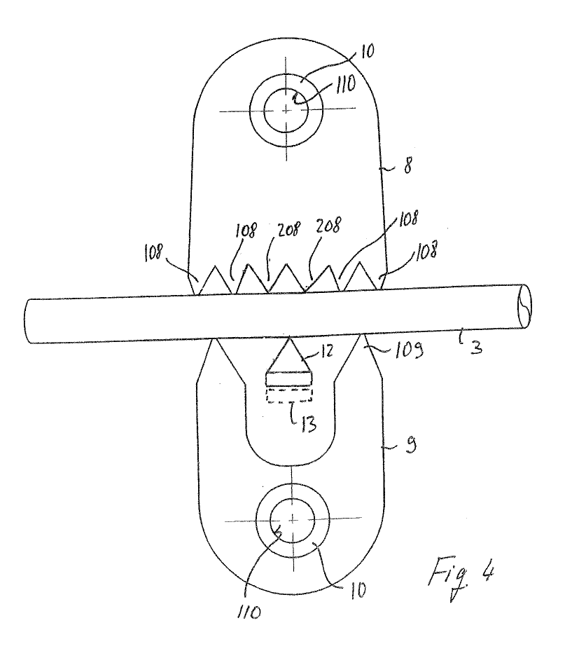

FIG. 4 is a front view of the two anti-intrusion deforming/blocking jaws and of the wedge-like deforming member in combination with a section of the optical fibre cable shown in the not blocked and not deformed condition.

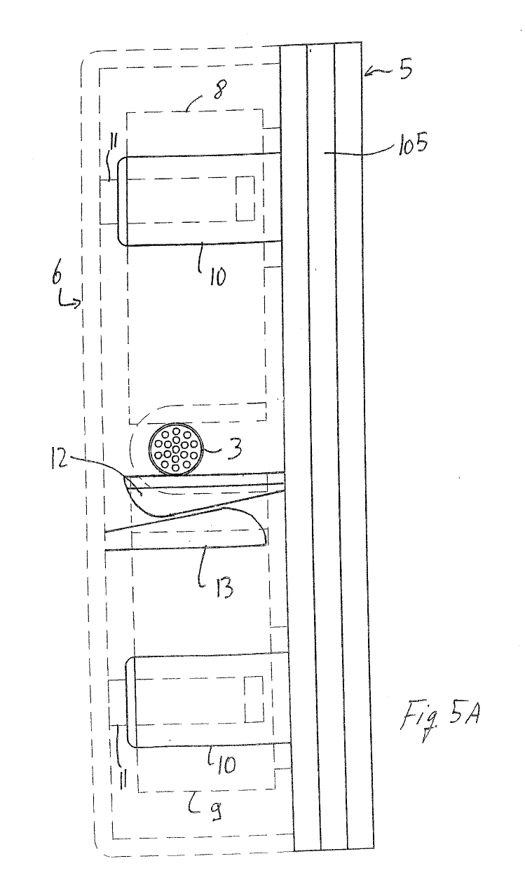

FIGS. 5 A, 5B and 5C show a partially sectional side view of the box housing anti-intrusion jaws and anti-tampering deforming members, the cover being in the condition coupled to the bottom wall, in partial moving way condition and in completely separated condition respectively.

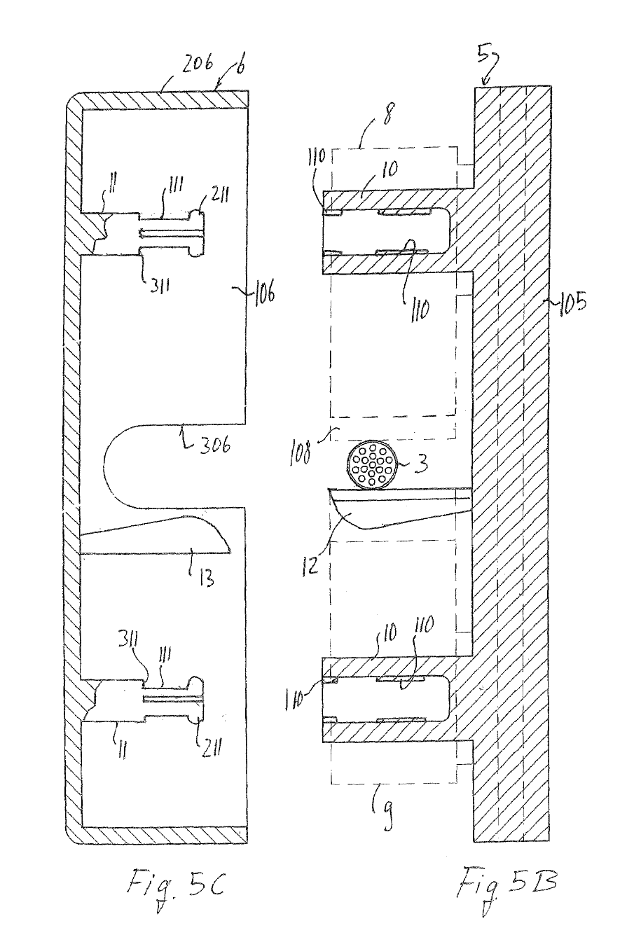

FIG. 6 is a perspective exploded view of the box containing means fastening the optical fibre cable, with the cover in the open condition.

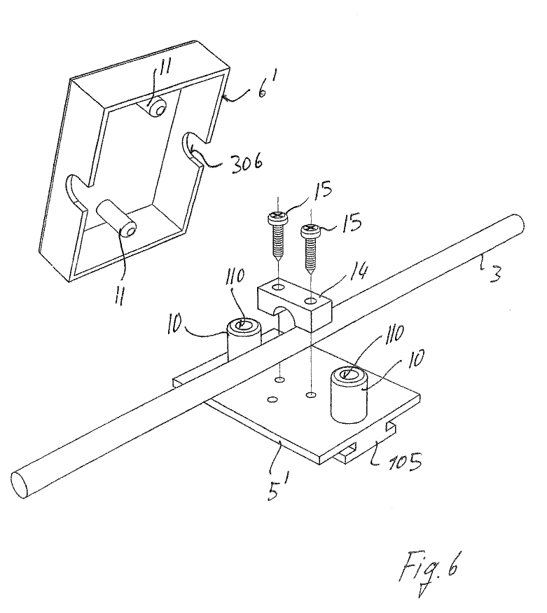

FIG. 7 is a cross-sectional view of the optical fibre cable in combination with a covering and protecting member.

Referring to figures, a preferred embodiment of the anti-intrusion device according to the present invention is shown intended for protecting a conventional fence composed of a metal net 2 vertically arranged and supported by a plurality of vertical poles 1. The anti-intrusion device is composed of a plurality of optical fibre cables 3 subtended in the longitudinal direction of a section or a perimeter of a fence to be protected. Said optical fibre cables 3 are supported or holded each at a different height from ground and parallely one with respect to the other, at a plurality of vertically arranged struts 4. In the shown embodiment, each strut 4 is fastened to the outer side of a corresponding pole 1 of the fence. By means of this arrangement, it is not necessary for the strut 4 to be anchored to the ground, but solutions different from the one that is shown are possible. For example, struts 4 can be provided in positions not corresponding to poles 1, and can be independently anchored to the ground, or poles 1 of the fence cannot be present and the metal net 2 can be directly fastened on the inner side of struts 4. In a very simple solution, the inner fence composed of poles 1 and of the metal net 2 can be completely absent, and the protection action can be given only to the device according to the present invention.

Each cable 3 is composed of an optical fibre bundle 103 and of an outer protecting sheath 203, made of a relatively soft and deformable material. As said above, there are provided anti-intrusion means for the optical fibre cable 3 and anti-tampering means for the real device. Said means are housed inside a box, for example made of metal or plastic material, composed of a substantially rectangular bottom wall 5 and of a cover part 6 provided with greater lateral walls 106 and smaller lateral walls 206. Obviously the container shape disclosed is to be intended as a not limitative example, since the box can be manufactured in any other desired shape and fit for this purpose. In a substantially intermediate position of each of the two greater lateral walls 106 there is provided a recess 306 for the perfect passage of the optical fibre cable 3.

The bottom wall 5 of the box is fastened on the outer face of the strut 4 that is composed of a tubolar type pole. The bottom wall 5 is provided of a rear plate 105 made like a dovetail or the like that constitutes a slide that is slidably housed in a complementary guide 104 provided on the outer side of the strut 4. Thus, the bottom wall 5 may be slidably engaged in the guide 104, in order to be easily brought in the ideal position on the strut 4 and so to be easily fastened on the strut 4 at the desired height from ground by means of a fastening screw 7 having such a length that, in the tightened condition, it does not protrude outside the surface of the bottom wall 5 in order not to interfere with mobile parts of the device. As will be evident in the following, said fastening screw 7 is covered by said mobile parts and by the box cover 6 such that it is impossible to disassemble the box from the strut 4 without causing an alarm. Hence, in order to unscrew the screw 7 it is necessary to open the box and therefore the activation of anti-tampering means.

It is important to note that even in the case when an action slidably freeing the box with regard to the strut 4 is successful without alarms, that is also in the case wherein the clamping in place of the box can be eliminated without opening the box, in order to separate the box from the strut 4 it is necessary to slide it along the guide 104 till the free end opening. This requires all boxes provided on the strut 4 to be separated from the strut 4, thus increasing probabilities that more than one abusive disassembling operations leads to an alarm condition and prolonging to a very great extent times for operations.

As said above, in the shown embodiment, the strut 4 is tubolar and on one side, that is on the side for the application of the box fastening the optical fibre cable and/or the box containing anti-intrusion deforming and/or blocking members and anti-tampering members, it has a tubolar guide 104 with a C-shaped section that is open with a median longitudinal slot along the wall adhering to said boxes. Boxes have a rear protrusion composed of plate-shaped slider 105 that is carried overhangingly and at a predetermined distance from the rear face of the bottom wall 5 of the box by a rib 205 or a rear extension. The slider is composed of a plate having a width that is greater than the longitudinal slot and it has surfaces abutting against the inner side of the two wall parts on the two sides of the slot. The rib 205 or the rear extension have such a thickness to pass freely through the longitudinal slot. Moreover the bottom wall 5 of the box, the slider 105 and the rib 205 form two grooves for slidably engaging the two wall strips that laterally delimit the slot and the faced surfaces of the slider 105 and of the bottom wall 5 which are spaced apart such that at least a fastening screw 7 engaged in a threaded through hole of the bottom wall 5 of the box can be brought in contact with the corresponding wall strip of the guide 104 delimiting on at least a side the longitudinal slot of the guide 104 itself, exerting an action fastening said wall strip between the screw 7 and the slider 105, so that the assembly of box and slider 105 are locked in position inside the longitudinal guide 104. The strut 4 or at least the longitudinal slot 104 are open on at least an end side.

In addition to above functional advantages, the manufacturing of the strut 4 with the open section longitudinal guide 104 allows to manufacture struts 4 by extrusion, for example by cutting aluminium tubolar section bars. The only processing step subsequent to the extrusion is composed of the length perfect cutting, while the guide 104 with the longitudinal slot 104 on the side fastening the box to the strut 4 can be manufactured simultaneously with the extrusion of the section bar itself. Thanks to what said above, operating steps necessary to fasten boxes, fastening devices and deforming and/or blocking means to struts 4 are highly reduced, even the number and the type of constructive parts to be kept in stock are highly reduced.

The device further comprises a pair of jaws 8, 9 one 9 of which is like a fork, that are opposite mounted and at opposite parts with respect to the optical fibre cable 3 each of which is pivoted at the tip region in a free pivotable manner on a cylindrical tubolar pin 10, 11 in the direction of the axis of the optical fibre cable 3. The two pins 10 are provided on opposite sides with respect to the optical fibre cable 3 and come out perpendicularly from the bottom wall 5. Two jaws 8, 9 are arranged in a common plane that is parallel to the bottom wall 5 and coplanar with the axis of the optical fibre cable 3. The two jaws 8, 9 are symmetrically arranged with respect to the optical fibre cable 3. Each end of the pivotable fork-like jaw 9, is made like a peak 109, while the other pivotable jaw 8 on the side faced towards the optical fibre cable 3 and towards the other fork-like jaw 9 has a notched surface composed of a row of six symmetric peaks, and with their tips contained in the same plane. Each of the two pair of end peaks 108 cooperates with the faced peak 109 of the fork-like jaw 9 with anti-intrusion function, while the pair of central peaks 208 has an anti-tampering function that will be disclosed in more detail hereinafter. Each pair of end peaks 108 delimit a V notch with a shape substantially complementary to each of peaks 109 of the fork-like jaw 9. Each peak 109 of the fork-like jaw 9 is arranged at such a distance from the corresponding double end peak 108 of the other jaw 8 to engage substantially perfectly and/or to slightly compress without deformation the only outer sheath 203 of the optical fibre cable 3, in the rest condition of jaws 8, 9. Upon an increase in stretching the optical fibre cable 3, due for example to a pull/deflection action exerted thereon, the two jaws 8,9 are dragged by the cable 3 itself so to pivot by a circle arc in the direction of the increase in stretching, by means of the slight engagement of peaks 109 and of double end peaks 108 with the outer sheath 203 of the cable 3. Tips of peaks 109 of the first fork-like jaw 9 and tips of double end peaks 108 of the second jaw 8 move in the direction of the increase in stretching along circle arc paths that slightly intersect one with the other, and approach one to the other going in the central region, so that a portion of the optical fibre cable 3 is deformed and/or blocked between the peak 109 of the first fork-like jaw 9 and the faced pair of end peaks 108 of the second jaw 8 arranged more distant from the point where the stretching has been applied on the optical fibre cable 3. Thus, the optical signal transmitted through the optical fibre cable 3 is attenuated below a predetermined threshold value, signalling the attempt of intrusion. It has to be noted that position of jaws 8, 9 may be different with respect to the one just disclosed, that is with positions inverted one with respect to the other. In case, there can be provided a greater number of pairs of jaws 8, 9 still arranged at opposite parts with respect to the optical fibre cable 3 which at the same time provide to deform/block the cable 3 upon an increase in stretching the latter. It has to be further noted that the two jaws 8, 9 are made such to allow the action deforming/blocking the cable 3 both in one direction and in the opposite one parallely to the axis of the cable 3, depending on the point where the stretching has been applied.

It is further provided a pair of substantially cylindrical pins 11 coming out perpendicularly from the inner face of the cover part 6, each of which two pins 11 is provided in a position corresponding to that of one of the two pins 10 pivotting jaws 8, 9 coming out perpendicularly from the box bottom wall 5. The two pivotting pins 10 are made tubolar and the inner hole has a diameter that substantially corresponds to the diameter of the two pins 11 provided on the cover part 6. When the cover part 6 approaches the bottom wall 5 for closing the box, each of the two pins 11 of the cover axially slidabing engage inside the corresponding pin 10 of the bottom wall 5. Thanks to this arrangement, the action opening/closing the box can be carried out moving away/approaching the cover part 6 from/to the bottom wall 5 according to one single fixed direction perpendicular to said bottom wall 5. As will be more evident in the following, this arrangement is important referring to anti-tampering means for the real device. Each pin 11 of the cover part 6 has a fork-like final end 111 with radially enlarged and rounded head 211 intended to cooperate with an annular radial narrowing 110 of the insertion hole of the corresponding tubolar pin 10 of the box bottom wall 5. The relative axial position between the outer edge of the insertion hole and the radial narrowing 110 of the insertion hole and the relative axial position between stop abutment radial step 311 on the corresponding pin 11 of the cover part 6 and the radially enlarged head 211 of the fork-like end 111 of the pin 11 of the cover part 6 are such that, in condition stopping the insertion of one pin 11 of the cover part 6 inside the insertion hole of the corresponding tubolar pin 10 of the box bottom wall 5, the radially enlarged head 211 of the pin 11 of the cover part 6 is passed at the back of the radial narrowing 110 of the insertion hole, referring to the insertion direction. Thanks to this arrangement, the cover part 6 is constrained to the box bottom wall 5 according to a predetermined fixed direction that is perpendicular to said bottom wall 5 in a predetermined axial position, referring to the coupling direction, and a certain force is required for moving away the cover part 6 from the bottom wall 5 that anyway can be carried out only according to said fixed direction. It has to be noted that the presence of the stop abutment radial step 311 on each pin 11 of the cover 6 is given by the fact that the fork-like final end 111 has a diameter that is slightly smaller than the remaining part of the pin 11 that substantially has the same diameter of the enlarged head 211.

As mentioned above, anti-tampering means for the box are provided, which are composed by the pair of central peaks 208 of the pivotting jaw 8, whose tips, in the rest condition of the jaw 8, are in contact with the external sheath 203 of the optical fibre cable 3, which central peaks 208 delimit a central notch intended to cooperate with a blocking wedge-like means 12 coming out perpendicularly from the inner face of the box bottom wall 5. Said blocking wedge-like means 12 is arranged in the gap between the optical fibre cable 3 and the opening of the pivotting fork-like jaw 9, with its tip turned towards the notch delimited by central peaks 208 and in contact with the outer sheath 203 of the optical fibre cable 3. A pushing member 13 is further provided coming out perpendicularly from the inner face of the cover part 6 providing to move by deflection the blocking wedge-like member 12 in the direction of the hollow delimited by the two central peaks 208 from a position not interfering with the optical fibre cable 3 in the closed condition of the box, to a position deforming and/or blocking the optical fibre cable 3 between the blocking wedge-like member 12 and the faced double central peaks 208 of the jaw 8 when the cover 6 is at an intermediate position moving away from the box bottom wall 5. As said above, the blocking wedge-like member 12, in the rest condition, is oriented substantially perpendicularly to the box bottom wall 5, while in the intermediate position moving away the cover 6 from the box bottom wall 5, it is oscillated by the pushing member 13 towards the optical fibre cable 3 and the faced hollow delimited by the two central peaks 208. To this aim, the tip of the blocking wedge-like member 12 in the rest condition, has a substantially vertical position with respect to the bottom wall 5, while the opposite side turned towards the fork-like jaw 9 has an eccentric V-shaped section, with a shorter and steeper face oriented in the direction of the free end of the blocking wedge-like member 12 and a longer and less steep face that descends gradually in the direction of the foot attaching the blocking wedge-like member 12 to the bottom wall 5 of the box. However, the pushing member 13 on its side turned towards the fork-like jaw 9 in the closed condition of the cover 6 has a substantially vertical position with respect to the inner face of the cover 6, while the opposite side turned towards the jaw 8 has also an eccentric V-shaped section, with a shorter and steeper face oriented in the direction of the free end of the pushing member 13 and a longer and less steep face that gradually descend in the direction of the foot attaching the pushing member 13 to the inner face of the cover 6. Thanks to these arrangements, both the pushing member 13 and the blocking wedge-like member 12 are provided with an enlargement, that anyway can have a shape different from the disclosed one, for example a lenticular one or the like. When the cover 6 partially is moved away from the bottom wall 5 because of an attempt of intrusion, the two enlargements cooperate one with the other, and, while the pushing member 13 maintains a position substantially perpendicular to the inner face of the cover 6 and to the bottom wall 5 of the box, the blocking wedge-like member 12 is oscillated in the direction of the cable 3 that is deformed and pushed inside the notch delimited by the two central peaks 208 of the jaw 8 causing an alteration of the transmitted optical signal that signals an alarm. It has to be noted that, in the closed condition of the box, the tip of the wedge of the blocking wedge-like member 12 is substantially coplanar to tips of peaks 109 of the fork-like jaw 9, therefore it slightly contacts the outer sheath 203 of the cable without deforming it. However, in the same conditions, even tips of central peaks 208 of the jaw 8 slightly contact the outer sheath 203 of the cable 3 without deforming it. From that it results that a minimum oscillation movement of the blocking wedge-like member 12 is sufficient for causing the deformation of the cable 3 and so for causing the alarm. The sensibility and reliability of the system are two further very advantageous characteristics. FIGS. 5A, 5B and 5C show in sequence what said above. In FIG. 5A the box in its closed condition is shown, therefore with the cover part 6 in the condition completely approaching the bottom wall 5. In this condition, the pushing member 13 and the blocking wedge-like member 12 both have a position substantially vertical to the bottom wall 5 and to the inner face of the cover 6, while, in condition wherein the cover 6 partially moves away from the bottom wall 5 (FIG. 5B), the pushing member 13 maintains its vertical position while the blocking wedge-like member 12 is oscillated in the direction of the cable 3 by the sliding of the enlargement of the pushing member 13 on the surface of the enlargement of the blocking wedge-like member 12. In this condition the cable 3 is subjected to a deformation. In the condition when the cover 6 is completely moved away from the bottom wall 5 the blocking wedge-like member 12 elastically returns in its vertical position with respect to the bottom wall 5, while the optical fibre cable 3 progressively gets back to its straight position. The reversibility of the deformation of optical fibre cable 3 is a further advantage of the system that can be restored in a very easy way. The partially rounded shape of slidably cooperating surfaces of the blocking wedge-like member 12 and of the pushing member 13 and the direction constraint in moving away the cover 6 in the direction perpendicular with respect to the bottom wall 5 helps the proper operation of the system. Hence pins 11 of cover 6 and pins 10 of the bottom wall 5 act also as centering members for the system and in order to univocally position the pushing member 13 with respect to the blocking wedge-like member 12.

It has to be noted that deforming/blocking means in combination with anti-tampering means disclosed up to now are provided only at points fastening the optical fibre cable 3 of only some struts 4, since it is provided that the optical fibre cable 3, at some struts 4, is provided with simple means for fastening them to said struts 4. Said fastening means are housed in a box that can be opened, that as regards the outside is equal to the box housing blocking jaws 8, 9, formed by a bottom wall 5′ and a cover part 6′ and it can be similarly fastened on the strut 4. Fastening means are composed of a bridge 14 for fastening by means of screws 15 the cable 3 to the bottom wall 5′ without significantly deforming the cable 3 itself. Means for closing said box are also equal to what said above with regard to the box containing anti-intrusion jaws 8, 9.

A longitudinal member 16 covering and protecting the optical fibre cable 3 can be further provided at portions comprised between two adjacent struts 4, such to avoid damaging the cable 3 for example because of rodents or the like. Said protecting member 16 is composed of a member with a C-section and with an inner diameter that substantially corresponds to the one of the optical fibre cable 3. It is open on one side such to be applied on the optical fibre cable 3. Two branches of the C-section of the member 16 continue parallely one with respect to the other to such an extent to avoid an easy admission to the cable 3 from the open part of the covering member 16.

All members disclosed up to now composing the anti-intrusion device according to the present invention can be made of any material fit for this purpose, particularly metal or plastic material.

Naturally the invention is not limited to the above disclosed and shown embodiment, but it can be widely varied, without departing from the guiding principle disclosed above and claimed below.

1. An anti-intrusion device for fences or the like, comprising at least one, preferably two or more cables (3), each one composed of at least one or a bundle of optical fibres (103) and of an outer protection sheath (203), which optical fibre cables (3) are subtended in a substantially longitudinal direction of a section or a perimeter to be protected and are supported or holded each one at a different height at a plurality of supporting points spaced apart arranged and wherein, at least at some of said supporting points, first means (8, 9) deforming and/or blocking each optical fibre cable (3) are provided, which first deforming and/or blocking means (8, 9) may be moved from a rest position in which they do not interfere with the optical fibre cable (3) to an active position deforming and/or blocking the optical fibre cable (3) in which an optical signal transmitted through the optical fibre cable (3) is attenuated under a predetermined threshold value or it is anyway modified, and which first deforming and/or blocking means (8, 9) are automatically operated upon an increase in stretching the optical fibre cable (3), for example due to a pull/deflection action exerted on the optical fibre cable (3), characterized in that said first deforming and/or blocking means (8, 9) are housed in a box provided with two box parts (5, 6) that can be separated and coupled one with the other, inside this box there being provided means (13, 12, 208) for anti-tampering and for signalling the opening of the box that are operated deforming and/or blocking the optical fibre cable (3) upon a relative movement separating said two parts (5, 6) of the housing box.

2. A device according to claim 1, characterized in that anti-tampering means of the box housing first deforming and/or blocking means (8, 9) are composed of second means (12, 208) deforming and/or blocking the optical fibre cable (3) that are operated deforming and/or blocking the optical fibre cable (3) by the relative movement separating the two parts (5, 6) of the box.

3. A device according to claims 1 and 2, characterized in that the housing box is composed of a stable bottom wall (5) and of a movable cover part (6), while second means deforming and/or blocking the optical fibre cable (3) are composed at least of two members (12, 208) that are constrained to the box bottom wall (5), which two deforming and/or blocking members (12, 208) are moved from a position not interfering with the optical fibre cable (3) in the closed condition of the box, to a position deforming and/or blocking the optical fibre cable (3) by means of activation means (13) constrained to the inner face of the cover (6) when the latter is in an intermediate position moving away from the box bottom wall (5).

4. A device according to one or more of the preceding claims, characterized in that the stable bottom wall (5) and the movable cover part (6) have mutual engagement and coupling centering means (10, 11) intended to prevent relative transversal movements between said two box parts (5, 6), such that the coupling/uncoupling of the cover part (6) to/from the bottom wall (5) occurs according to a predetermined fixed direction.

5. A device according to one or more of the preceding claims, characterized in that said fixed direction for coupling/uncoupling the cover part (6) to/from the bottom wall (5) of the box is orthogonal to the bottom wall (5) of the box and to the inner face of the cover (6), the bottom wall (5) of the box and the cover part (6) being provided with complementary mutual coupling/uncoupling guides (10, 11) that are oriented perpendicularly to the bottom wall (5) of the box and to the inner face of the cover (6).

6. A device according to one or more of the preceding claims, characterized in that said coupling/uncoupling guides are composed at least of a pair of substantially cylindrical pins (11) coming out perpendicularly from the inner face of the cover part (6), each of said two pins (11) is provided in a position corresponding to that of one of two tubolar pins (10), that is with a substantially cylindrical axial hole, coming out perpendicularly from the bottom wall (5) of the box such that, when the cover part (6) approaches the bottom wall (5) for closing the box, each one of the two pins (11) of the cover (6) engage by axially sliding inside the hole of the corresponding tubular pin (10) provided on the bottom wall (5) of the box.

7. A device according to one or more of the preceding claims, characterized in that there are provided complementary movable engagement means (111, 110), for example of the snap type, by forcing or the like, between each pin (11) of the cover part (6) and the corresponding tubolar pin (10) of the box bottom wall (5).

8. A device according to one or more of the preceding claims, characterized in that means (311, 110) for stopping the insertion of each pin (11) of the cover part (6) in the hole of the corresponding tubolar pin (10) of the box bottom wall (5) are provided.

9. Device according to one or more of the preceding claims, characterized in that said movable engagement means are composed of at least a radial enlargement (211), particularly an annular one, of the outer cylindrical wall of each pin (11) of the cover part (6) and/or of at least a radial narrowing (110), particularly an annular one, of the inner cylindrical wall of the inserting hole of each of the two tubolar pins (10) of the box bottom wall (5), and/or vice-versa.

10. A device according to one or more of the preceding claims, characterized in that each pin (11) of the cover part (6) has a final fork-like end (111) with radially enlarged and rounded head (211) that cooperates with an annular radial narrowing (110) of the inserting hole of the corresponding tubolar pin (10) of the box bottom wall (5), the relative axial position between the edge of the inserting hole and the inner radial narrowing (110) of the inserting hole and the relative axial position between a stop abutment radial step (311) on the corresponding pin (11) of the cover part (6) and the radially enlarged head (211) of the fork-like end (111) of the pin (11) of the cover part (6) being such that, in condition stopping the insertion of one pin (11) of the cover part (6) inside the insertion hole of the corresponding tubolar pin (10) of the bottom wall (5) of the box, the radially enlarged head (211) of the pin (11) of the cover part (6) is passed at the back of the radial narrowing (110) of the insertion hole, referring to the direction of insertion.

11. A device according to one or more of the preceding claims, characterized in that second deforming and/or blocking means having the function of anti-tampering and signalling the opening of the cover (6) are composed of a first blocking member arranged in a stable way in the bottom wall (5) of the box and provided with a pair of peaks (208) delimiting a notch, and of a second blocking member (12), cooperating with the first blocking member, that is a wedge-like or peak-like one faced on the notch and it can be elastically deformed in the direction of the notch, between said two members (208, 12) the optical fibre cable being perfectly interposed with regards to the distance between the faced tips, a third pushing member (13) being further provided, constrained to the inner face of the cover part (6) providing to move the second blocking wedge-like member (12) in the direction of the hollow of the first blocking member from a position not interfering with the optical fibre cable (3) in the closed condition of the box, to a position deforming and/or blocking the optical fibre cable (3) between the 5 second blocking wedge-like member (12) and faced double peaks (208) of the first blocking member when the cover (6) is in an intermediate position moving away from the box bottom wall (5).

12. A device according to one or more of the preceding claims, characterized in that the third pushing member (13) is oriented perpendicularly to the inner face of the cover (6), the first blocking member with double peaks (208) is oriented perpendicularly to the bottom wall (5) of the box, while the second blocking wedge-like member (12), in rest condition not deforming and/or blocking the optical fibre cable (3), is oriented substantially perpendicularly to the bottom wall (5) of the box, while, in intermediate moving away position of the cover (6) from the bottom wall (5) of the box, it is pivoted by the third pushing member (13) in the direction of the optical fibre cable (3) and of the faced hollow of the first blocking member.

13. A device according to one or more of the preceding claims, characterized in that the second wedge- or peak-like blocking member (12) has, near its free end, an enlarged part or an enlargement extending in a direction opposite to that of the wedge, while the pushing member (13) constrained to the inner face of the cover (6) has, near its free end, a corresponding enlarged region or an enlargement oriented in the direction of the second wedge-like blocking member (12), so that when the box is closed and the cover (6) completely approaches the bottom wall (5), the second blocking wedge-like member (12) is oriented perpendicularly to the bottom wall (5) of the box and it does not interfere with the optical fibre cable (3), while, when the cover (6) is partially moved away from the box bottom wall (5), the two enlargements cooperate one with respect to the other and the second wedge-like blocking member (12) is elastically deformed and it pivots in the direction of the optical fibre cable (3) that is deformed and pushed inside the notch of the first blocking member.

14. A device according to one or more of the preceding claims, characterized in that each of the two enlargements of the second wedge-like blocking member (12) and of the pushing member (13) may be composed for example of a projection, particularly a lenticular one, having at least a rounded shape, or the like.

15. A device according to one or more of the preceding claims, characterized in that the enlargement provided on the pushing member (13) constrained to the inner face of the cover (6) has an eccentric V-shaped section, with a shorter and steeper face oriented in the direction of the free end of the pushing member (13) and a longer and less steep face that descends gradually in the direction of the foot attaching the pushing member (13) to the inner face of the cover (6), and the enlargement provided on the second wedge-like blocking member (12) has also an eccentric V-shaped section, with a shorter and steeper face oriented in the direction of the free end of the wedge-like blocking member (12) and a longer and less steep face that gradually descends in the direction of the foot attaching the wedge-like blocking member (12) to the box bottom wall (5).

16. A device according to one or more of the preceding claims, characterized in that first deforming/blocking means that are operated upon an increase in stretching the cable (3) due for example to a pull/deflection action exerted thereon, are composed of a pair of jaws (8, 9) that are opposite mounted and at opposite parts with respect to the optical fibre cable (3) and are freely pivotable on pins (10) in the direction of the axis of the optical fibre cable (3), which jaws (8, 9), at rest condition, engage with a predetermined force two opposite regions of the outer sheath (203) of the optical fibre cable (3) without deforming it, while, upon an increase in stretching the optical fibre cable (3), they are dragged by the cable (3) itself so to pivot by a circle arc in the direction of stretching/pull exerted on the optical fibre cable (3), causing the optical fibre cable (3) to be deformed and/or blocked causing the transmitted optical signal to be varied.

17. A device according to one or more of the preceding claims, characterized in that optical fibre cable or cables (3) are fastened or supported, each one at a different height, at a plurality of vertical or substantially vertical struts (4), such as poles or the like, that are spaced apart arranged and wherein, at least at some of said vertical struts (4), a box housing first (8, 9) and second (12, 12, 208) deforming/blocking means is provided.

18. A device according to one or more of the preceding claims, characterized in that each one of the two jaws (8, 9) is composed of a fork-like member pivoted at tip region in a free pivotable manner on a cylindrical pin (10) coming out perpendicularly from the box bottom wall (5), the two pins (10) being provided on opposite sides with respect to the optical fibre cable (3) and arranged perpendicularly to the axis of the strut (4) and to the axis of the optical fibre cable (3), the two fork-like jaws (8, 9) being arranged in a common plane parallel to the axis of the strut (4) and coplanar with the optical fibre cable (3), and the two fork-like jaws (8, 9) being arranged symmetrically with respect to the optical fibre cable (3) and with mutually faced openings, and ends of said fork-like jaws (8, 9), at rest position of fork-like jaws (8, 9), being in contact with the outer sheath (203) of the optical fibre cable (3) so to achieve at least an engagement of only the outer sheath (203) with the optical fibre cable (3) by friction or a slight compression.

19. A device according to one or more of the preceding claims, characterized in that each end of a first pivotable fork-like jaw (9) is made like a point or a peak (109), while each end of the second pivotable fork-like jaw (8) has a pair of tips or peaks (108) side by side that delimit a V notch with a shape substantially complementary to each one of two peaks (109) of the first fork-like jaw (9), each peak (109) of the first fork-like jaw (9) being arranged at such a distance from the corresponding double peak (108) of the second fork-like jaw (8) to engage substantially perfectly and/or slightly compressing without deformation the only outer sheath (203) of the optical fibre cable (3), at rest condition of pivotable fork-like jaws (8, 9).

20. A device according to one or more of the preceding claims, characterized in that tips of peaks (109) of first fork-like jaw (9) and tips of double peaks (108) of the second fork-like jaw (8), when the stretching of the optical fibre cable (3) increases, move in the direction of the increase in stretching along circle arc paths that are at least tangent, particularly slightly intersecting one with respect to the other, so that a portion of the optical fibre cable (3) is deformed and/or blocked between the peak (109) of the first jaw (9) and the faced double peak (108) of the second jaw (8) arranged more distant from the point where the pull action is applied on the optical fibre cable (3).

21. A device according to one or more of the preceding claims, characterized in that the cover part (6) may be provided with lateral openings (306) for perfect passage of the optical fibre cable (3).

22. A device according to one or more of the preceding claims, characterized in that the two pins (10) around which the two fork-like jaws (8, 9) pivot are composed of the same two tubolar pins (10) fastening the cover part (6) to the box bottom wall (5).

23. A device according to one or more of the preceding claims, characterized in that the first anti-tampering blocking means with double peak (208) is arranged in the gap comprised between the two branches of the second fork-like jaw (9) and the optical fibre cable (3), while the second wedge-like blocking and anti-tampering means (12) is provided in the gap comprised between two branches of the first fork-like jaw (8) and the optical fibre cable (3), or vice-versa.

24. A device according to one or more of the preceding claims, characterized in that tips of the double peaks (208) of the first blocking member are coplanar with tips of the two pairs of peaks (108) of the second fork-like jaw (8), while the tip of the wedge of the second wedge-like blocking member (12) is coplanar with the tip of peaks (109) of the first fork-like jaw (9).

25. A device according to one or more of the preceding claims, characterized in that the second pivotable fork-like jaw (8), on the side turned towards the optical fibre cable (3), has a notched surface composed of a row of six, preferably symmetric peaks (108, 208), and with their tips contained in a same plane, the two central peaks (208) and the hollow delimited thereby constituting the first anti-tampering blocking means, while each one of the two pairs of end peaks (108) cooperate with one peak (109) of the first fork-like jaw (9) with anti-intrusion function.

26. A device according to one or more of the preceding claims, comprising a plurality of struts (4) and at least an optical fibre cable (3) that is fastened to said struts (4), characterized in that first deforming/blocking means (8, 9) in combination with means (12, 13, 208) signalling the opening or tampering of said deforming/blocking means (8, 9) are provided only at points fastening the cable (3) of only some struts (4), at least a strut (4) without said deforming/blocking means (8, 9) being provided interposed between two struts (4) provided with said means (8, 9), while on said struts (4) without said first deforming/blocking means (8, 9) there are provided simple means (14, 15) fastening the cable (3) to said struts (4), which fastening means (14, 15) are housed in an openable box, that as regards the outside is substantially equal to the box housing first deforming/blocking means (8, 9).

27. A device according to claim 26, characterized in that the box for fastening means (14, 15) has a bottom wall (5′) and a cover part (6′) that can be movably coupled one with the other, and means signalling the opening and/or tampering of the box being provided between cover (6′) and bottom wall (5′).

28. A device according to one or more of the preceding claims, characterized in that optical fibre cables (3) are horizontally arranged, while struts (4) or beams supporting them are arranged in an inclined way towards the inside or outside of a perimeter to be protected.

29. A device according to one or more of the preceding claims, characterized in that optical fibre cables (3) are vertically arranged while supporting struts (4) are horizontally arranged.

30. An anti-intrusion device for fences or the like, totally or partially as disclosed, shown and for above aims.
